(19) United States
(12) Patent Application Publication
(10) Pub. No.: US 2006/0254409 A1
(43) Pub. Date: Nov. 16, 2006

(54) Sorting media files using dynamic passive recognition techniques

(76) Inventor: Ryan L. Withop, Foster City, CA (US)

Correspondence Address: BROWN RAYSMAN MILLSTEIN FELDER & STEINER LLP, 303 TWIN DOLPHIN DRIVE, SUITE 600, REDWOOD SHORES, CA, 94065, US

(21) Appl. No.: 11/432,195

(22) Filed: May 10, 2006

Related U.S. Application Data
(60) Provisional application No. 60/680,254, filed on May 11, 2005.

(51) Int. Cl. G10H 1/00

(52) U.S. Cl. 84/601

(57) ABSTRACT

A method comprises storing information regarding content previously played by a user, the information including a playback frequency; determining new content similar to the content previously played; scoring the new content based on the stored information; and sorting the new content based on the scoring. The method may comprise computing a frequency of relatedness based on the number of times new content was determined to be similar, and may score the new content based on the frequency of relatedness. The content may be considered previously played if the playback time exceeded a wait time. The new content may include repeats, a current or future scheduled broadcast, content available for download, and/or content stored locally. The determining step may include comparing channel number, metadata, content frequency, genre, author, artist, album and/or keywords. The method may comprise generating a weighting factor magnifying relevance of the new content, possibly based on desired variety.

### PRIORITY CLAIM

This application claims priority to and incorporates by reference U.S. Provisional Application No. 60/680,254, filed on May 11, 2005, by Ryan Withop, entitled “Satellite Radio Interface to Automobile Touchscreen or Video Display Device.”

### TECHNICAL FIELD

The invention relates to car audio electronics, searching algorithms, broadcast television and radio, satellite television and radio, and downloadable media content such as audio, video, and podcast technologies.

### BACKGROUND

More and more music options have become available to drivers of automobiles since the invention of portable radio. Driver's previously had five preset FM stations and five preset AM stations to choose from with limited content available. Now the use of satellite radio has provided over one hundred channels (and growing) of diverse audio content. Navigating through this large set of choices has become increasingly difficult and increasingly distracting from driving.

What is needed are a system and method that enable easier music selection and are less distracting to a driver.

### SUMMARY

By displaying music options most relevant to the driver's preferences at the time they are available, a driver can select his or her music in significantly less time than “Channel Surfing.” By passively recording what music the user has played and combining this information with information about related media content, one embodiment of the invention filters and ranks content available from broadcast or downloadable sources that the user would most likely enjoy listening to.

Broadcast radio may also be stored on a device for later listening. A feature enabled by an embodiment of the invention allows a user to jump only to the stored songs he or she is most likely to prefer, skipping over stored radio content that is not of interest to the user. This is both a more satisfying experience for the user but also reduces the interaction required by the user down from several clicks and several seconds of distraction away from driving to a single click that requires little to no driver attention, resulting in a much safer driving experience. Embodiment of the invention may minimize wasted time with digital media, allowing users to skip over podcasts, newsletters, and video media clips that are irrelevant to the user's interests.

As users become more selective, the content they choose to store becomes more selective. Using an embodiment of the invention, devices can look at future content according to provided schedules to automatically determine future media that may be of interest. For instance, one could scan HD radio channels or satellite radio channels and automatically jump to a channel at the time when a preferred song plays. In the field of digital music and mp3 players, automatically, a better playlist can be generated and new content can be downloaded based upon previous playback history and rankings for a related artist not yet heard. In the video world, digital video recorders could better recommend related future programming to record if content one previously watched was monitored and ranked. In the podcasting world, a software routine could determine related podcasts of interest for subscription and download automatically to increase a user's variety of programming.

In one embodiment, the present invention provides a method comprising storing information regarding media content previously played by a user, the information including a playback frequency; determining new media content similar to the media content previously played by the user; scoring the new media content based on the stored information; and sorting the new media content based on the scoring. The media content may include one of audio, video and/or multimedia content. The method may further comprise computing a frequency of relatedness based on the number of times the determining step identified the new media content as similar to the media content previously played, and wherein the scoring step includes scoring the new media content based on the stored information and on the frequency of relatedness. The media content may be considered previously played if the playback time exceeded a wait time. The new media content may include repeats of media content previously played, a future scheduled broadcast, a current broadcast, media content available for download from a remote database, and/or media content stored in a local database. The step of determining may include comparing channel number, metadata, content frequency, content genre, author, artist, album and/or keywords. The method may further comprise generating a weighting factor magnifying relevance of the new media content. The step of generating a weighting factor may include determining an amount of desired variety. The method may generate a playlist based on the scoring, the playlist being a subset of the new media content.

In another embodiment, the present invention provides a system comprising a database for storing information regarding media content previously played by a user, the information including a playback frequency; a related media finder for determining new media content similar to the media content previously played by the user; a scoring module for scoring the new media content based on the stored information; and a sorting module for sorting the new media content based on the scoring. The media content may include one of audio, video and multimedia content. The scoring module may determine a frequency of relatedness based on the number of times the related media finder identified the new media content as similar to the media content previously played, and may score the new media content based on the stored information and on the frequency of relatedness. The system may also include a playback extractor that determines media content previously played if the playback time exceeded a wait time and that stores the media content previously played into the database. The new media content may include repeats of media content previously played, a future scheduled broadcast, a current broadcast, media content available for download from a remote database, and/or media content stored in a local database. The related media finder may determine new media content by comparing at least one of channel number, metadata, content frequency, content genre, author, artist, album and keywords. The scoring module may score or the sorting module may sort the new media content by generating a weighting factor magnifying relevance of the new media content. The scoring module or sorting module may generate the weighting factor based on an amount of desired variety. The system may also include a sorting module for generating a playlist based on the scoring generated by scoring module, the playlist being a subset of the new media content.

In another embodiment, the present invention may provide a system comprising means for storing information regarding media content previously played by a user, the information including a playback frequency; means for determining new media content similar to the media content previously played by the user; means for scoring the new media content based on the stored information; and means for identifying the new media content based on the scoring.

### BRIEF DESCRIPTION OF THE DRAWINGS

FIG. 1 shows a media device such as a portable computer with a display, used for selecting and playing music, audio books, podcasts, video, broadcast audio or broadcast video.

FIG. 2 details a controller and remote input device which controls the display and playback of a portable audio or video device, in accordance with another embodiment of the present invention.

FIG. 3 details the construction of a media device.

FIG. 4 lists various software application modules which control the selection, display and retrieval of relevant available media content, in accordance with an embodiment of the present invention.

FIG. 5 details how related music, video, or other media content is retrieved, in accordance with an embodiment of the present invention.

FIG. 6 details how the content currently available is stored into a database.

FIG. 7 details how the system determines the value or score for a particular piece of media based upon dynamic, passive user preferences, in accordance with an embodiment of the present invention.

FIG. 8 lists the equations utilized in scoring and filtering results of content available for display, in accordance with an embodiment of the present invention.

### DETAILED DESCRIPTION

By displaying music options most relevant to the driver's preferences at the time they are available, a driver can select his or her music in significantly less time than “Channel Surfing”. By passively recording what music the user has played and combining this information with information about related media content, one embodiment of the invention filters and ranks content available from broadcast or downloadable sources that the user would most likely enjoy listening to.

Broadcast radio may also be stored on a device for later listening. A feature enabled by an embodiment of the invention allows a user to jump only to the stored songs he or she is most likely to prefer, skipping over stored radio content that is not of interest to the user. This is both a more satisfying experience for the user but also reduces the interaction required by the user down from several clicks and several seconds of distraction away from driving to a single click that requires no driver attention, resulting in a much safer driving experience. Embodiment of the invention may minimize wasted time with digital media, allowing users to skip over podcasts, newsletters, and video media clips that are irrelevant to the user's interests.

As users become more selective, the content they choose to store becomes more selective. Using an embodiment of the invention, devices can look at future content according to provided schedules to automatically determine future media that may be of interest. For instance, one could scan HD radio channels or satellite radio channels and automatically jump to a channel at the time when a preferred song plays. In the field of digital music and mp3 players, automatically, a better playlist can be generated and new content can be downloaded based upon previous playback history and rankings for a related artist not yet heard. In the video world, digital video recorders could better recommend related future programming to record if content one previously watched was monitored and ranked. In the podcasting world, a software routine could determine related podcasts of interest for subscription and download automatically to increase a user's variety of programming.

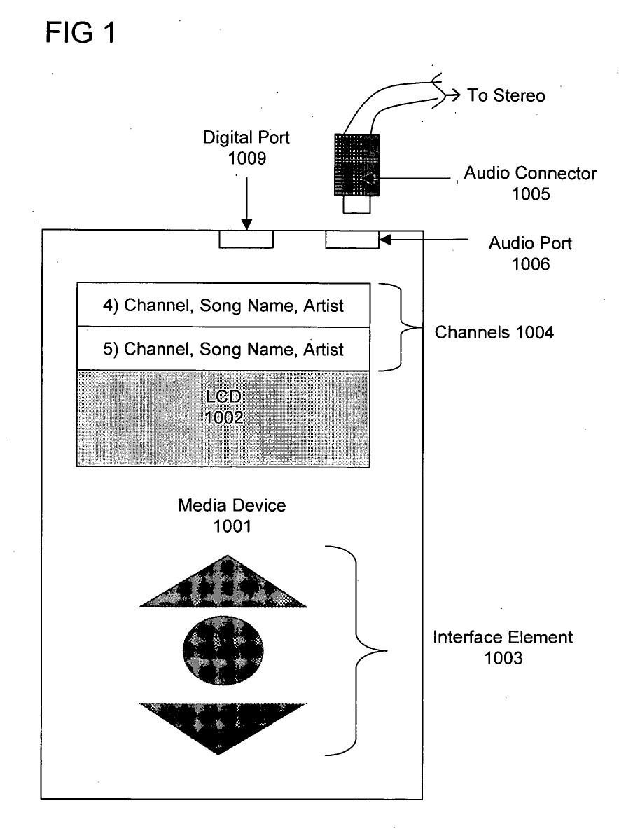

Referring to FIG. 1, the system described is a Media Device 1001, which is a computer used for processing data and playing audio video or text content, and includes a Liquid Crystal Display (LCD) 1002, which displays information to a user, an Interface Element 1003 such as buttons to instruct the Media Device 1001 what to do, and Channels 1004 which are displayed on the LCD 1002. The Interface Element 1003 may take the form of a touch screen such as those found in automobiles or may be in the form of a remote control. Channels 1004 represent broadcast content available for playback or recording. In another embodiment, Channels 1004 represent content already stored on the Media Device or stored on a networked computer available for download. Generally, a Channel 1004 may contain an audio, video, podcast, or text content and metadata that describe the categorization of the content such as a channel number, artist or creator of the content, title, comments, and perhaps a genre or set of keywords to categorize that particular content with similar content. A podcast is usually an audio or video clip provided to a user through the RSS (Really Simple Syndication) method to which subscribed content is downloaded to a user's Media Device 1001. The content may be a live broadcast, content previously stored on the device, content available for download, or content available at a future time according to a predefined, broadcasted schedule.

An Audio Connector 1005 carries an analog audio signal back to a stereo for hearing the audio portion when plugged into the Audio Port 1006 which transmits the audio signal. Digital Port 1009 may be utilized in an embodiment in which an external computer is used to control the Media Device 1001. The Digital Port 1009 is a digital communications port such as a Universal Serial Bus (USB) or proprietary connection format, including wireless communication strategies. The Media Device 1001 may be considered to be a handheld player with a tuner and may take the form of a Personal Digital Assistant, a Digital Music Player, a Personal Video Player, or a portable satellite radio/television receiver. Other embodiments for the Media Device 1001 include embedded computers, laptop computers, personal home computers and cell phones capable of playing media files.

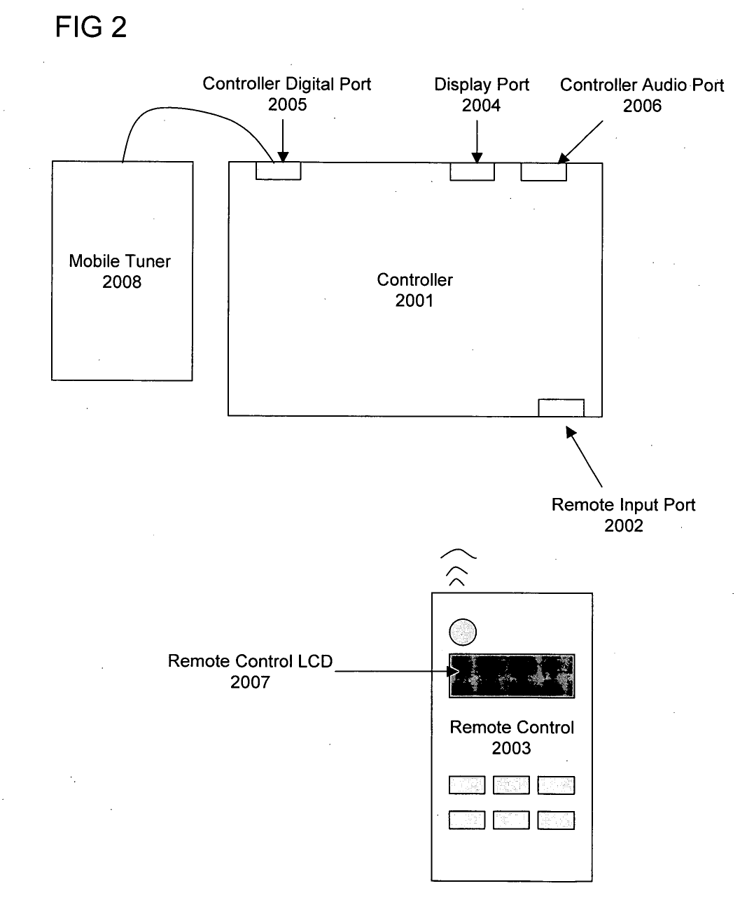

Referring now to FIG. 2, the system is composed of an alternate embodiment in which the Media Device 1001 is replaced with a Mobile Tuner 2008. A Mobile Tuner 2008 is similar to the Media Device 1001 in that it has a tuner for receiving audio or video broadcasts and the ability to download content. But, it differs in that the Mobile Tuner 2008 does not have an LCD 1002 or Interface Elements 1003. The Mobile Tuner 2008 may gather content for the user in an automotive, boating or home environment in conjunction with an external controller.

Digital communication with another system called the Controller 2001 controls the display and playback of Channels 1004 available and of files stored on the Media Device 1001. The Controller 2001 contains a Remote Input Port 2002 which receives user requests through technologies such as Infrared, Radio Frequency, Bluetooth, or WiFi from the Remote Control 2003, which may contain a Remote Control LCD 2007 for more convenient display. The Controller 2001 also may contain a Display Port 2004 for sending video output to an external video device such as a television or automobile information display and may contain a Controller Audio Port 2006 for playback of the music that is streamed from the Mobile Tuner 2008. The Controller Digital Port 2005 allows commands to be sent to control the Mobile Tuner 2008 and may receive a digital stream of content for playback if external analog ports are not available on the Mobile Tuner 2008. In one embodiment, the Mobile Tuner 2008 may be replaced by the Media Device 1001 if a Digital Port 1009 is available on the Media Device 1001. In some cases, the Mobile Tuner 2008 has an analog audio port and video port for connection with monitors and audio equipment, instead of playback routed through the Controller 2001.

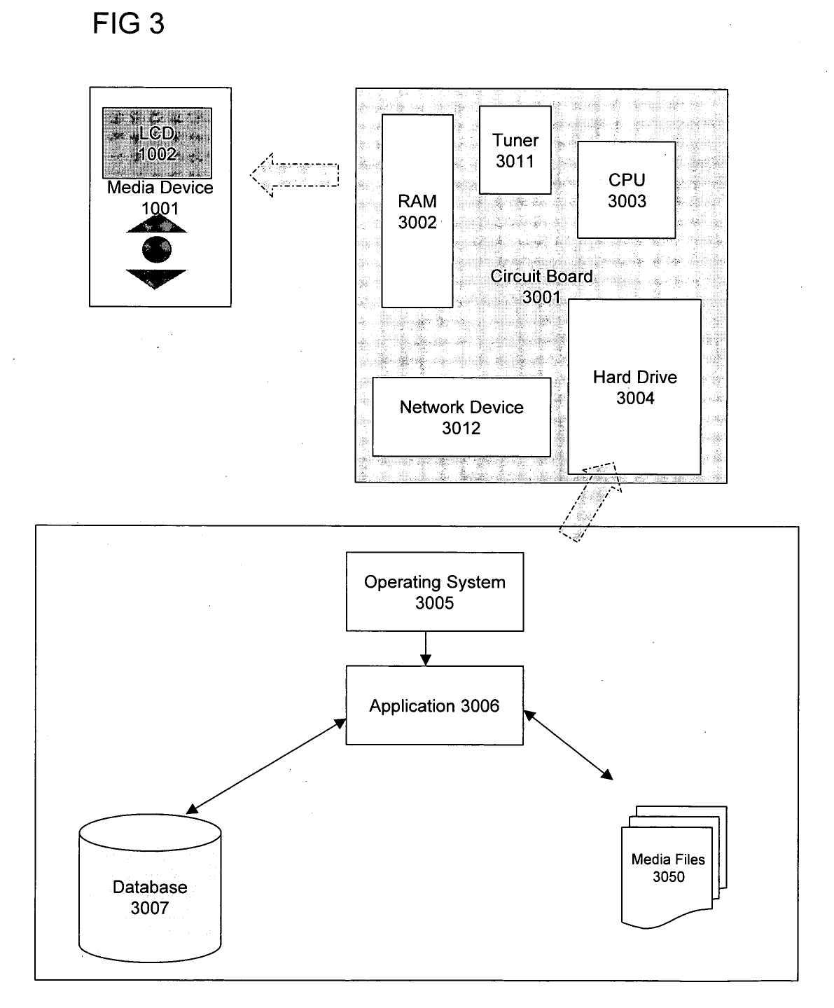

Referring now to FIG. 3, in one embodiment, the Media Device 1001 from FIG. 1 contains a Circuit Board 3001 which carries electrical signals to make a computer function, Random Access Memory (RAM) 3002 which holds information or “data” in memory, a Central Processing Unit (CPU) 3003 which computes values and passes those values to other circuits on the circuit board via electrical signals, and a Hard Drive 3004 which permanently stores information such as data files. In another embodiment the Hard Drive 3004 may be replaced with or include other types of permanent storage such as a flash drive. In this embodiment, although not shown, the Circuit Board 3001 may include the Audio Port 1006, Display Port 2004, and Remote Input Port 2002.

A Tuner 3011 provides access to Channels 1004, much in the same way a television tuner works. The Tuner 3011 allows reception of what is playing on the Channels 1004 and metadata about that content, and allows the user to tune a particular Channel 1004 for playback. Typically a tuner takes the form of a satellite radio tuner, AM/FM or HD radio tuner, or similar satellite, cable and VHF television tuners. An Operating System (OS) 3005 controls various circuits and provides a platform for applications to run. An Application 3006, sometimes referred to as a “Program” is executable computer code that runs on an OS 3005 and provides the user a way to interact with the Media Device 1001 or Controller 2001 from FIG. 2 and perform particular functions. A Database 3007 is a structured way of holding data and determining relationships between the data for easy retrieval. In one embodiment of the invention, the Database 3007 holds metadata about user preferences on music, video and text content such as news and newsletters. The Database 3007 also holds information on what content is available for playback. Media Files 3050 are audio files, video files, podcasts, blogs, text, graphics or other audio-visual data that are stored on the Hard Drive 3004 of the Media Device 1001. In some cases these may be partial files holding streaming content that is broadcast to the Media Device 1001. Applications 3006 query the Database 3007 to determine content available for playback or recording. The Network Device 3012 provides a means for the Media Device 1001 to communicate to the Internet to retrieve or send additional data. This may be in the form of a Network Interface Card (NIC). The Network Device 3012 is used for gathering metadata about the media content, downloading scheduling data if necessary, streaming of digital audio and video files, and for downloading content. While the contents of the Media Device 1001 have been described here, these components in FIG. 3 may also represent the components of the Controller 2001 and/or the Mobile Tuner 2008.

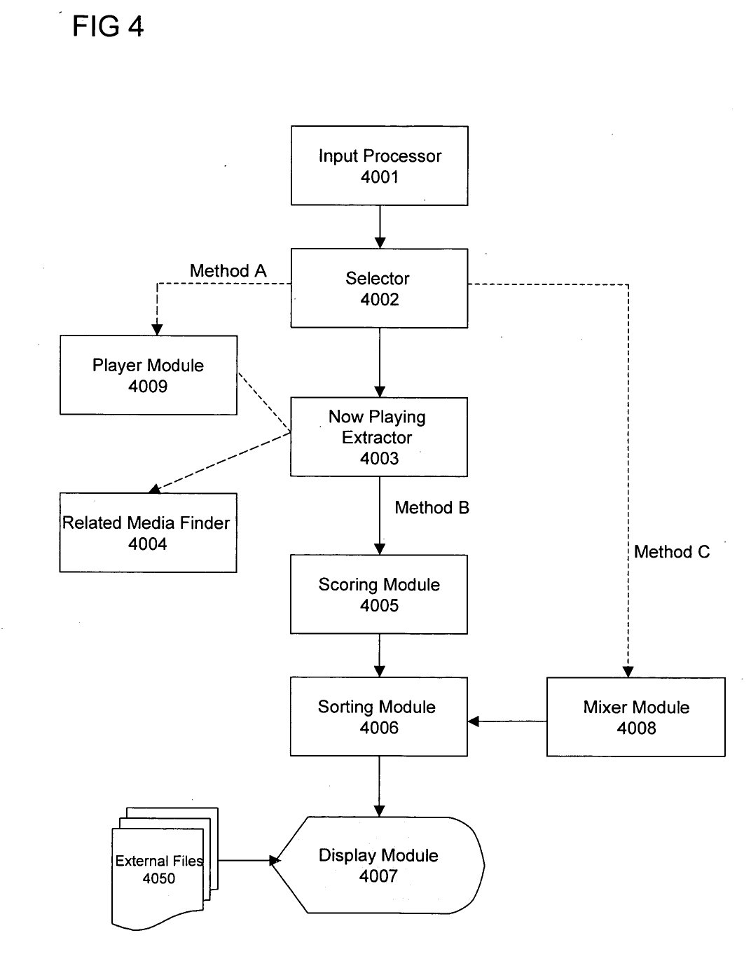

FIG. 4 is a flow diagram illustrating details of the application 3006. An Input Processor 4001 receives input, e.g., from the user via Interface Elements 1003 on the Media Device 1001 of FIG. 1 or from a Remote Control Device 2003 of FIG. 2. A Selector 4002 accepts commands from the Input Processor 4001 and performs the desired action, which in some cases is to play a particular Channel 1004 from FIG. 1, to display the set of preferred media now playing, or to alter the variety of preferred media currently displayed. A Now Playing Extractor 4003 determines what is playing, has played, or is scheduled to play on the Channels 1004 from FIG. 1 and stores it in a database. The Now Playing Extractor 4003 also records the frequency of each song or video that has been played by the user. A Related Media Finder 4004 determines what Artists, Creators, Songs, Videos, or Podcasts are related to the media currently selected by the user and stores this list in a database. A Scoring Module 4005 determines matches between a user's preferences and what media is available and applies a score to each Channel 1004 from FIG. 1 that may be of interest to the user. A Sorting Module 4006 determines what of the set delivered by the Scoring Module 4005 should be displayed and in what order. A Display Module 4007 displays the resulting set of user preferred media to the LCD 1002 of FIG. 1. A Mixer Module 4008 alters the results from the Sorting Module 4006. External Files 4050 are files that are used by the Display Module 4007 to modify the appearance or formatting of the displayed data. A Playback Module 4009 enables playback of the media content.

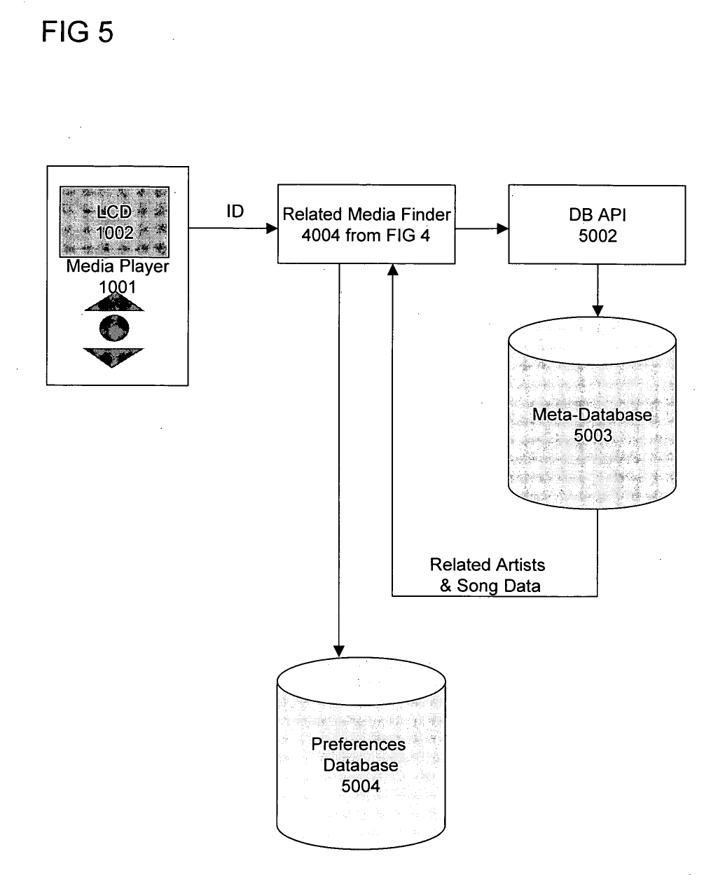

Referring to FIG. 5, the Related Media Finder 4004 transfers identifying information about the media clip currently selected by the user and submits it to the DB API 5002. The DB API 5002 is a Database Application Programming Interface which accepts commands for retrieving data from the Meta-Database 5003. The Meta-Database 5003 stores relationships between media utilizing metadata criteria such as the mood, genre, artist or creator, and specific aspects found in common between two media clips. The Meta-Database 5003 may be locally stored on the Hard Drive 3004 from FIG. 3 or may be located on a networked computer and accessed using Internet Protocols via the Network Device 3012 from FIG. 3. In one embodiment, the Related Media Finder 4004 extracts a unique identifier in the form of a series of alphanumeric characters and in return receives a list of artists related to the artist who created the media. A unique identifier may also be in the form of the Artist Name and Song Name on the currently playing Channel 1004. The unique identifier may also be a short segment of audio or video. The DB API 5002 contains a fingerprinting technology to receive the unique identity and associate it with a particular record in the Meta-Database 5003. In one embodiment, the results returned from the Meta-Database 5003 are a list of related songs. In another embodiment, the results are related creators, authors, or artists of podcasts and videos. Results from the query of the Meta-Database 5003 are stored in the User Preferences Database 5004.

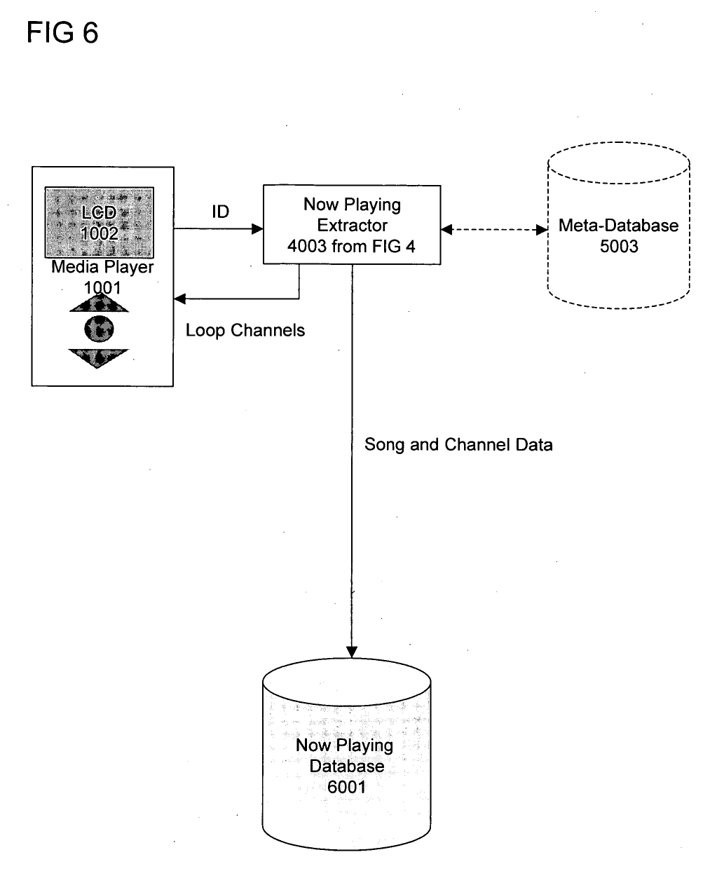

Referring to FIG. 6, the Now Playing Extractor 4003 from FIG. 4 extracts the unique identity for each song, video, or Media File 3050. If necessary, the Now Playing Extractor 4003 may request additional metadata about the song or video playing by sending this unique identity to the DB API 5002 and subsequent Meta-Database 5003 from FIG. 5. The returned set of data may include artist/creator name, song or video name, and album or collection name as well as other categorizing information. The Now Playing Extractor 4003 loops through each available Channel 1004 from FIG. 1 and stores a record for each channel in the Now Playing Database 6001. The Now Playing Database 6001 records are overwritten each time, such that only the current set of available content is contained. In another embodiment where a history of past media files available are needed, the data is not overwritten and an entire schedule of media file occurrences are saved.

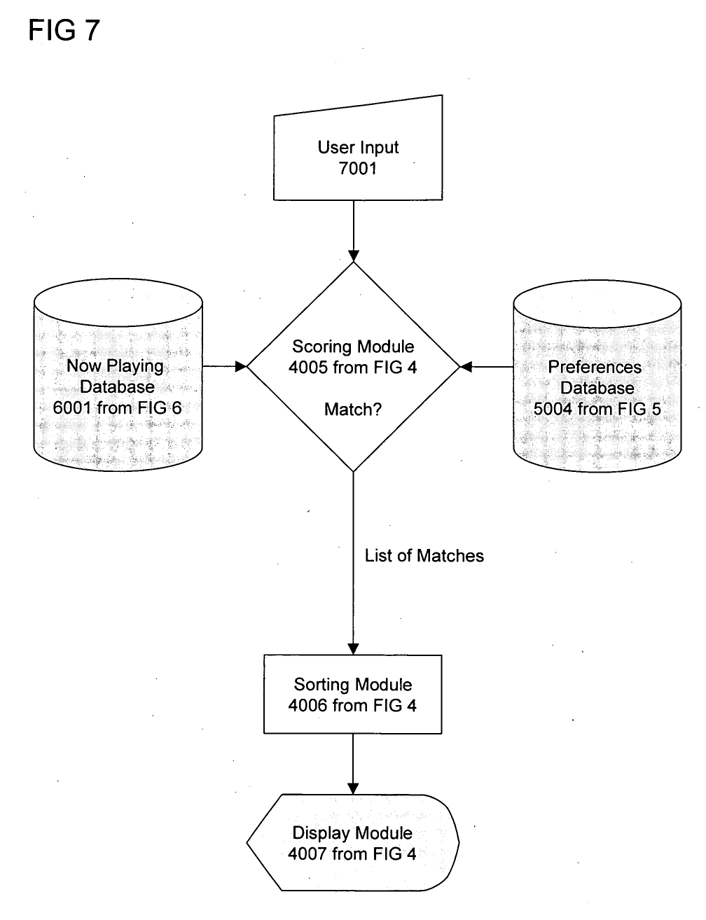

Referring to FIG. 7, the Scoring Module 4005 from FIG. 4 compares media files the user has previously played to media files currently playing or available for playback and recording. User Input 7001 is a request by the user of the Media Device 1001 via the Interface Elements 1003. In this case, the request may be to display a list of available media files based upon the interest of this user. The Scoring Module 4005 compares the Preferences Database 5004 from FIG. 5 to the Now Playing Database 6001 from FIG. 6 and ranks the results based upon a given formula that combines the frequency at which this particular content has been played before and whether this content is related to other content that has been previously played. The results of this comparison are passed to the Sorting Module 4006 from FIG. 4 to determine which of these results to display and in what order. This information is then passed to the Display Module 4007 from FIG. 4 for display on the LCD 1002 from FIG. 1.

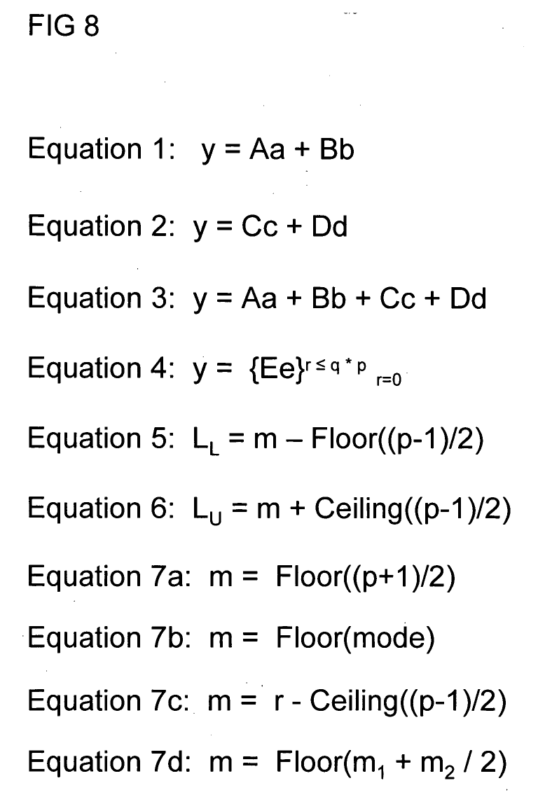

Referring to FIG. 8, Equation 1 details how a score is given to a Channel 1004 based solely upon whether the content has been played before or is recommended based upon other content already played. In Equation 1, ‘y’ represents the total score given to a Channel 1004. ‘A’ represents a weighting factor used to magnify the relevance of ‘a’ the number of times a particular song or video has been previously played. ‘B’ represents a weighting factor used to magnify the relevance of ‘b’ the number of times a related song or media has had this song in its list of related content. Generally weighting factor ‘A’ is larger than weighting factor ‘B’, suggesting that a user's ultimate preference is greater towards songs or videos that have been played in the past, although the Sorting Method 4006 allows a user to override this to provide more variety. This method may result in a modest size Preferences Database 5004 but perhaps too narrow variety to be useful to the user.

Equation 2 details how a score ‘y’ is calculated based upon a weighting factor ‘C’ multiplied by the number of times the artist being scored ‘c’ has been previously played plus the weighting factor ‘D’ multiplied times the number of times a previously played related artist has recommended the artist being scored. Generally weighting factor ‘C’ is larger than weighting factor ‘D’, suggesting that a user's ultimate preference is greater towards artists that have been played in the past, although the Sorting Method 4006 allows a user to override this to provide more variety.

Equation 3 details the calculation of a score ‘y’ for content available based upon both the content's specific playing frequency and that of the artist. In Equation 3 ‘A’, ‘B’, ‘C’, ‘D’, ‘a’, ‘b’, ‘c’, and ‘d’, represent the same variables as in Equations 1 and 2. This equation may result in a large Preferences Database 5004 but perhaps the most flexibility in determining a user's preferences. Generally weighting factor ‘A’ is larger than ‘B’ which is larger than ‘C’, which is larger than ‘D’. The actual values and their relative size are up to manufacturers.

An optional set of factors is included in Equation 4, where ‘E’ is a weighting factor applied to ‘e’ the number of times a particular Channel 1004 that is being scored has been played. This is referred to as “Channel Popularity.” Generally ‘E’ would be quite a small value in comparison to other weighting factors since it is least related to what the user prefers and since ‘e’ is generally orders of magnitude higher than ‘a’, ‘b’, ‘c’, or ‘d’ in Equations 1, 2, and 3. It is noteworthy that ‘E’ and ‘e’ are only calculated if the number of results available for the user is not sufficient to provide adequate variety. “Adequate Variety” is subject to the discretion of the manufacturer of the device. One possibility is to only compute Equation 4 if the number of items available for display is less than the number of display slots multiplied by the number of variety option settings. Only Channels 1004 that are not already found in the matching results of available media will be summed and returned.

Equation 5 describes the lower limit ‘LL’ for display. It represents the position in the list of results with the highest score that will be displayed. The variable ‘m’ is the pivot point of the set of Channels 1004 that will be returned and varies based upon the number of results available and the variety setting selected by the user. The number of items requested to display is the variable ‘p’. The Floor function rounds a number down to the next lowest integer, while the Ceiling function rounds a number up to the next highest integer.

Equation 6 describes the upper limit ‘LU’ for display. Again ‘m’ represents the pivot point of the set, while ‘p’ is the number of items requested for display. The upper limit is the position of the lowest score that will be displayed for this variety setting.

Equation 7a shows the calculation of variable ‘m’ in the case of “least variety” such that only the top ‘p’ number of scores will be displayed. Equation 7b shows the calculation of variable ‘m’, which is the lowest integer near the statistical mode of the result set. This represent the middle setting of variety. Equation 7c shows the calculation of variable ‘m’ when the “most variety” is requested by the user. The variable ‘r’ represents the number of results available. This equation results in the bottom most scores being displayed up to ‘p’ number of items. Equation 7d shows the calculation of ‘m’ for settings between the middle variety and either the least variety or most variety settings. ‘LU’ and ‘LL’ are calculated in Equations 5 & 6 based upon the value of ‘m’ from the user's variety setting.

Describing Method A of FIG. 4 in more detail, a user requests playback of a specific song or video. When this event occurs, a command is sent to the Media Device 1001 to playback the Media File 3050 or to tune to the selected broadcast Channel 1004. This request is processed by the Input Processor 4001 which handles interpreting the electrical signal sent by the Interface Element 1003. When the Interface Element 1003 is located on the Media Device 1001, the electrical signal is typically a voltage change sensed by the Input Processor 4001, which in turn looks up the appropriate value to send to the Selector 4002 based upon which button was pushed, what was displayed on the LCD 1002 and what was currently selected by the user. When the user request comes from a Remote Control Device 2003 of FIG. 2, the Input Processor receives the data from an Infrared or Radio Frequency Receiver, looks up the appropriate value and sends this value on to the Selector 4002. When the Controller 2001 or Media Device 1001 is run on a Windows or UNIX/Linux Operating System 3005, the signal received may be processed by comparing input command values to an XML file listing associated alphanumeric characters to be sent to the Selector 4002 program.

The Selector 4002 performs the request, calling the Plaback Module 4009 to play the selected channel. The Selector 4002 then initiates the Now Playing Extractor 4003 after a designated wait time has elapsed. This designated wait time may be the duration at which a Media File 3050 or Channel 1004 has been considered to be sufficiently played such that the user has an interest in this file and is not just browsing casually. A possible wait time may be around 1 minute and 15 seconds, although other wait times greater or lesser are acceptable. Once this threshold has been met, the Media File 3050 playing is recorded in the “played” table of the User Preferences Database 5004 with metadata about the content such as title and artist, and is given a score of one for this occurrence.

The Related Media Finder 4004 then returns a limited number of related media to the song recorded most recently in the “played” table. Related media data is stored in a table for “related” data in the Preferences Database 5004, while Media Files 3050 or Channels 1004 selected by the user are stored in the “played” table of the Preferences Database 5004. Each related data record is given a value of one. In one embodiment, the returned related media is a list of artists. In another embodiment, the return related media is a list of related songs included the song or video title, artist name, and other categorizing metadata. While the Now Playing Extractor 4003 passively records whether a song or video has been sufficiently played, a user may override this function to give higher preference to the particular song playing. If the user pushes this button, a multiplier replaces the singular score given to that song in the “played” table, giving it a higher overall score, such as two. The related records also increase their scores by the same factor. Just as a user can give higher preferences, a user can zero out the score for a song currently playing back pushing the correct button for this function. The user may also blacklist a particular song or artist completely by creating a record in the “blacklist” table of the User Preferences Database 5004. This table is read just prior to display of the matching results and removes all items in the matching results that match the blacklisted records.

Describing Method B of user interaction, the user has requested to see a list of Channels 1004 that match his or her preferences. Preferences for what Channels 1004 to display were previously stored in the Preferences Database 5004 based what songs or videos the user has previously played and what media closely related to that might also be enjoyable. This comparison is performed in the Scoring Module 4005. Each song or Media File 3050 that has been played for a sufficient length of time receives a score of one in the “played” table of the Preferences Database 5004. Each artist's score in this table is summed using a SQL Routine. Each song or media clip's score is also grouped and summed. Each artist and song score from the “related” table in the Preferences Database 5004 is also summed using a SQL Routine.

The Now Playing Extractor 4003 from FIG. 4 scans all of the available Channels 1004 to see what media content is available. This list is stored in the Now Playing Database 6001, but alternatively could be stored in a data structure such as an object, list, or array. The list of what's available is then compared to the queries of artists, songs, related artists, and related songs using a SQL query. Only Channels with matches will remain as results. The matching results are then scored to determine a priority for how they will be displayed to the user. The scoring is according to the equations in FIG. 8. Using Equation 2 of FIG. 8 as an example, the Scoring Module 4005 multiplies a weighting factor by the number of times this matching artist has been played in the past and adds to it a factor that includes how many times this artist was found in the related table as well. Alternatively or additionally, Equation 1 and/or Equation 3 could perform the comparison. Equation 1 may be found to restrict results to very close relatedness. Equation 3 may be found to give greater weight to very closely related songs but also give some flexibility to display artists that have been frequently heard but perhaps the particular song has not yet been heard. Finally, the matching results are sorted in descending total score.

The Sorting Module 4006 of FIG. 4 now determines what songs to display. This is based upon the number of songs to display variable ‘p’ from Equations 7a through 7d in FIG. 8, the number of results ‘r’, the number of variety settings ‘q’, and the particular variety setting selected by the user. The variety setting determines which of Equations 7a through 7d are selected. This cascades down to Equations 5 & 6 of FIG. 8 to ultimately determine the limits to the set that will be displayed. In the “least variety” user setting, Equation 7a would be selected for calculation of ‘m’. Assuming that p=3, Equations 5 & 6 could calculate that songs scored between the positions 1 and 3 will be displayed. Since the matching results are in descending order, the three highest total scoring songs and the Channel 1004 they are available on will be displayed to the user through the Display Module 4007 from FIG. 4. Equation 4 of FIG. 8 may be utilized when the number of returns is less that the number needed to show sufficient variety. In this case, the sum of channel scores appears in the “played” table of the Preferences Database 5004. All Channels 1004 that do not appear in the matching list of results receive a score according to Equation 4. This score is then appended to the matching results list and the list is reordered again in descending order, if necessary. Popular Channels 1004 not previously found in the results are now available and appear towards the bottom of the scores and thus closer to the most variety setting.

Another embodiment of sorting may be based on presenting the user a mixed set instead of displaying a set of subsequently scored Channels 1004. This is accomplished by selecting non-subsequently scored Channels 1004. One approach is to divide the results into equal sets and to select one Channel 1004 from each set. For instance, if there are twenty results and four may be displayed on the LCD 1002 at one time, then the results must be segmented into twenty divided by four parts. The sorting routine selects the highest score in each of these sets of five. This would give the user a large span of variety starting with a very popular song or media clip, a modestly popular song in the second set of five, a somewhat popular song in the third set, and finally a song that is not very popular, residing in the lowest scored set of results. Which selection method used in the Scoring Module 4005 is up to the manufacturer's preference.

Describing Method C of user interaction, the user has requested to change the variety of Channels 1004 or Media Files 3050 presented on the display. When the user asks for more variety, Channel 1004 with a lower score (that is, Channels 1004 with Songs, Videos, Artists or Creators that have been played less) will display. When a user selects less variety, Channels 1004 with higher scores will display. The Selector 4002 sends the appropriate keystroke command to the Mixer Module 4008 to change the display of results. There are at least three main methods for changing the results. One method is to change the weights used to calculate each portion of the score. For example, increasing variable A and decreasing variable B in Equation 3 would result in “less variety” since it would increase the scores of Channels 1004 with Media Files 3050 that have been played before, limiting the variety of music to mostly music heard before. This same approach could be applied to variables A, B, C, D, and E in Equations 1, 2, and 3. This is an acceptable approach; however in more complicated formulas such as Equation 3, less predictable results are likely. Another method of changing variety is to leave the original scores intact and purely change what is displayed. The easiest method for changing what is displayed is to simply display the subsequent set of Channels 1004 with lower scores. For example, if three Channels 1004 can be displayed on the LCD 1002, then in the setting with the least variety, only the top three scored Channels 1004 will be displayed. When the user requests less variety, the next three highest scores beneath those will be displayed on the LCD 1002.

When there are a large number of Channels 1004 that match user preferences, it may be advantageous to cover a larger span. This is accomplished using Equations 7a through 7d in FIG. 8. The variable ‘m’ is calculated in each equation for each variety setting. The upper and lower limits are then calculated in Equations 5 & 6 for each variety setting, thereby yielding a set of songs clustered around a particular variety setting. For example, if the number of songs that can be displayed, ‘p’, is equal to 3, and the number of matching results available, ‘r’, is equal to 18, then the middle variety setting would utilize Equation 7b to calculate ‘m’. In this case, ‘m’ represents the statistical mode. The “Flooro( )” of this mode would be 9. Calculating Equations 5 & 6 would dictate that positions 8 through 11 of the descending score list of matching available media should be displayed, for a middle variety selection. For the most variety setting, Equation 7c from FIG. 8 would be used, resulting in the lowest scores displayed, (i.e. positions 16, 17, and 18.) This method selects scores further down the list than a method that simply scrolls sequentially through the results. This affords a greater variety of options to the user.

1. A method comprising:
storing information regarding media content previously played by a user, the information including a playback frequency;
determining new media content similar to the media content previously played by the user;
scoring the new media content based on the stored information; and
sorting the new media content based on the scoring.

2. The method of claim 1, wherein the media content includes one of audio, video and multimedia content.

3. The method of claim 1,
further comprising computing a frequency of relatedness based on the number of times the determining step identified the new media content as similar to the media content previously played, and
wherein the scoring step includes scoring the new media content based on the stored information and on the frequency of relatedness.

4. The method of claim 1, wherein media content is considered previously played if the playback time exceeded a wait time.

5. The method of claim 1, wherein the new media content includes repeats of media content previously played.

6. The method of claim 1, wherein the new media content includes a future scheduled broadcast.

7. The method of claim 1, wherein the new media content includes a current broadcast.

8. The method of claim 1, wherein the new media content includes media content available for download from a remote database.

9. The method of claim 1, wherein the new media content includes media content stored in a local database.

10. The method of claim 1, wherein the determining includes comparing at least one of channel number, metadata, content frequency, content genre, author, artist, album and keywords.

11. The method of claim 1, further comprising generating a weighting factor magnifying relevance of the new media content.

12. The method of claim 11, wherein the generating a weighting factor includes determining an amount of desired variety.

13. The method of claim 1, further comprising generating a playlist based on the sorting, the playlist being a subset of the new media content identified as similar.

14. A system comprising:
a database for storing information regarding media content previously played by a user, the information including a playback frequency;
a related media finder for determining new media content similar to the media content previously played by the user;
a scoring module for scoring the new media content based on the stored information; and
a sorting module for sorting the new media content based on the scoring.

15. The system of claim 14, wherein the media content includes one of audio, video and multimedia content.

16. The system of claim 14, wherein
the scoring module determines a frequency of relatedness based on the number of times the related media finder identified the new media content as similar to the media content previously played, and
the scoring module scores the new media content based on the stored information and on the frequency of relatedness.

17. The system of claim 14, further comprising a playback extractor that determines media content previously played if the playback time exceeded a wait time and that stores the media content previously played into the database.

18. The system of claim 14, wherein the new media content includes repeats of media content previously played.

19. The system of claim 14, wherein the new media content includes a current broadcast.

20. The system of claim 14, wherein the new media content includes a future scheduled broadcast.

21. The system of claim 14, wherein the new media content includes media content available for download from a remote database.

22. The system of claim 14, wherein the new media content includes media content stored in a local database.

23. The system of claim 14, wherein the related media finder determines new media content by comparing at least one of channel number, metadata, content frequency, content genre, author, artist, album and keywords.

24. The system of claim 14, wherein the scoring module scores new media content by generating a weighting factor magnifying relevance of the new media content.

25. The system of claim 24, wherein the scoring module generates the weighting factor based on an amount of desired variety.

26. The system of claim 24, wherein the sorting module sorts new media content by modifying the weighting factor.

27. The system of claim 26, wherein the sorting module modifies the weighting factor based on an amount of desired variety.

28. The system of claim 14, further comprising a sorting module for generating a playlist based on the sorting generated by sorting module, the playlist being a subset of the new media content identified as similar.

29. A system comprising:
means for storing information regarding media content previously played by a user, the information including a playback frequency;
means for determining new media content similar to the media content previously played by the user;
means for scoring the new media content based on the stored information; and
means for sorting the new media content based on the scoring.
